(19) United States
(12) Patent Application Publication
(10) Pub. No.: US 2014/0162051 A1
(43) Pub. Date: Jun. 12, 2014

(54) White, weathering-resistant, biaxially oriented polyester film matt on at least one side, its use and process for its production

(71) Applicant: MITSUBISHI POLYESTER FILM GMBH, Wiesbaden (DE)

(72) Inventors: Martin JESBERGER, Mainz (DE); Holger KLIESCH, Ginsheim-Gustavsburg (DE); Bodo KUHMANN, Runkel (DE); Deborah ALTENHOFEN, Mainz (DE); Harald RUECKER, Waldems (DE)

(73) Assignee: MITSUBISHI POLYESTER FILM GMBH, Wiesbaden (DE)

(21) Appl. No.: 13/709,443

(22) Filed: Dec. 10, 2012

(51) Int. Cl. B32B 9/04; B32B 27/08; B32B 5/16

(52) U.S. Cl. CPC B32B 9/043; B32B 5/16; B32B 27/08
USPC 428/327; 428/323; 428/328; 428/330; 428/331; 428/329; 264/469; 264/210.1

(57) ABSTRACT

The invention relates to a white, biaxially oriented polyester film which has at least one polyester-containing base layer (B) and at least one white, matt outer layer (A), where the outer later (A) and the base layer (B) include, alongside the white pigment, other particles, preferably SiO₂, which have a median diameter of from 2 to 10 μm. The film is optionally functionalized on at least one surface. Films of this type feature in particular low weathering-resistant gloss of the outer layer (A), high whiteness, high UV protection, and high processing safety, and are therefore suitable for outdoor uses, in particular for use in roofing films.

### FIELD OF THE INVENTION

The invention relates to a white, weathering-resistant, biaxially oriented, coextruded polyester film which is matt on at least one side and which is comprised of a UV-resistant white base layer (B) which also comprises, alongside the white pigment, particles that provide mattness, and of at least one white, matt UV-resistant outer layer (A) which has been applied on said white, matt base layer (B) and which likewise comprises particles that provide mattness. The film features a characteristic matt surface of the outer layer (A), and this optical property is also retained after prolonged weathering. The film of the invention can moreover have at least one surface functionalized by coating, where this achieves by way of example good adhesion to polymer layers or metal layers or printing inks. The invention further relates to the use of the film and to a process for its production.

### BACKGROUND OF THE INVENTION

U.S. Pat. No. 3,154,461 describes a biaxially oriented film made of thermoplastic (e.g. polyethylene terephthalate, polypropylene) with matt surface which comprises incompressible particles (e.g. calcium carbonate, silicon dioxide) measuring from 0.3 to 20 μm at a concentration of from 1 to 25% by weight. For white applications, this film is too transparent and has inadequate whiteness. The matt appearance does not withstand prolonged weathering.

EP 1 900 515 A1 describes a white, coextruded, biaxially oriented polyester film, matt on one side, comprised of a white base layer (B) and of at least one matt outer layer (A) which has been applied on said white base layer (B). The film initially exhibits acceptable mattness, but alters its appearance on prolonged insolation; over the course of time, the film increases its gloss and thus provides less diffuse light-scattering. In the use in cladding on buildings, there is a risk that the increasing gloss will cause disturbance to air traffic.

### SUMMARY OF ADVANTAGEOUS EMBODIMENTS OF THE INVENTION

It was an object of the present invention to provide a white, biaxially oriented polyester film which is matt on at least one side and which does not have the disadvantages of the films of the prior art—in particular the films of EP 1 900 515 A1—and which in particular features high mattness—even after constant insolation over 10 years—at the same time as low transparency and high whiteness, very easy production, and very good processability. It should moreover be ensured that cut material arising during the production of the film can be returned to the production process as regrind waste without any resultant significant adverse effect on the physical and optical properties of the film.

The following definitions apply here:
high mattness: gloss <50, preferably <45, particularly preferably <40 (at 60° in accordance with DIN 67 530)
low transparency: <60%, preferably <50%, particularly preferably <40%; in accordance with ASTM D1003-61
high whiteness: >75, preferably >80, particularly preferably >85; Berger method (see description of method below)
weathering resistance: difference in mattness before/after weathering at most 20 units, preferably at most 10 units, and very particularly preferably at most 5 units
very easy production: less than 2 break-offs in the production process per 24 hours
very good processability: good windability, i.e. no telescoping (<1 cm per wind)
excellent physical properties: modulus of elasticity (longitudinal) from 3200 to 5400 N/mm², modulus of elasticity (transverse) from 3900 to 6800 N/mm² (measured in accordance with ISO 527-1 and ISO 527-3, type 2 test specimen), and/or tensile strength (longitudinal) from 120 to 260 N/mm², tensile strength (transverse) from 120 to 320 N/mm² (measured in accordance with ISO 527-1 and ISO 527-3, type 2 test specimen)
excellent optical properties: see above: mattness, transparency, and whiteness.

### DETAILED DESCRIPTION OF ADVANTAGEOUS EMBODIMENTS OF THE INVENTION

The object is achieved via a white, biaxially oriented polyester film which has at least one white, matt base layer (B) and at least one white, matt outer layer (A), where the outer layer (A) and the base layer (B) comprise, alongside the white pigment, other particles which increase mattness, and which have a median particle diameter d₅₀ of from 2 to 10 μm, and which are present at a concentration of from 1.0 to 7.0% by weight in each layer, where the particle diameter and the concentration in the two layers is identical or different. The concentration of the white pigment present in the outer layer (A) is from 2.0 to 15.0% by weight. The outer layer (A) moreover comprises a UV stabilizer at a concentration of from 0.3 to 8.0% by weight.

Unless otherwise stated, all of the percent by weight data are based on the composition of the layer to which said data apply.

Optionally, at least one of the two film surfaces has a functional coating, or a functional treatment has been provided thereto. The meaning of “functional” here is that another property that is usually not present or is present only to a small extent is provided to the film; by way of example, the film thus becomes sealable, printable, metalizable, sterilizable, or antistatic, or exhibits by way of example an improved aroma barrier, or permits adhesion to materials which would not otherwise adhere on the film surface. Said coating is preferably applied as aqueous dispersion to the film. In a preferred embodiment, a functional acrylate coating is applied to the matt outer layer (A).

In the invention, the film has at least two layers, and then comprises, as layers, the matt, white base layer (B) and the matt, white outer layer (A). In a preferred embodiment of the invention, the film has a three-layer structure, and then has the outer layer (A) of the invention on one of the sides of the base layer (B), and has a further outer layer (C) on the other side of the base layer (B). Again, this three-layer film of the invention optionally has, on at least one film surface, a functional coating, preferably applied as aqueous dispersion to the film.

The proportion of the base layer (B), based on the total thickness of the film, is at least 50%, preferably at least 60%, and particularly preferably at least 70%.

### Base Layer (B)

The polymer content of the base layer (B) of the film is preferably comprised of at least 80% by weight of thermoplastic polyester, preferably at least 90% by weight. These data for percentage by weight are based—as stated—on the polymer content of the layer; pigment content, particle content, or additive content is ignored here. Examples of materials suitable for this purpose are polyesters made of ethylene glycol and terephthalic acid (=polyethylene terephthalate, PET), made of ethylene glycol and naphthalene-2,6-dicarboxylic acid (=polyethylene 2,6-naphthalate, PEN), made of 1,4-bishydroxymethylcyclohexane and terephthalic acid [=poly(1,4-cyclohexanedimethylene terephthalate), PCDT], or else made of ethylene glycol, naphthalene-2,6-dicarboxylic acid, and biphenyl-4,4′-dicarboxylic acid (=polyethylene 2,6-naphthalate bibenzoate, PENBB).

Preference is given to polyesters which are comprised of at least 90 mol %, in particular at least 95 mol %, of units derived from ethylene glycol and from terephthalic acid, or of units derived from ethylene glycol and from naphthalene-2,6-dicarboxylic acid (where the basis of 100 mol % is provided by the polyester or copolyester). The remaining units derive from other aliphatic, cycloaliphatic, or aromatic diols and, respectively, dicarboxylic acids, these being those that are usually used by the person skilled in the art in producing copolyesters.

In a very preferred embodiment, the base layer is comprised of polyethylene terephthalate homopolymer.

Polyesters of this type can be purchased or if necessary—produced by processes known to the person skilled in the art, for example by copolymerization of the individual monomers or by way of masterbatches of various individual polymers.

The base layer (B) comprises, alongside the polymer described above, a white pigment at a concentration of from 3 to 15% by weight, preferably from 4 to 14% by weight, and particularly preferably from 5 to 13% by weight. Detailed information relating to the white pigment follows at a later stage below in the “White pigment” section.

The base layer (B) moreover comprises particles at a concentration of from 1 to 7% by weight, where these particles are particles differing from the white pigments. The additional particles in the base layer are at least chemically identical with the particles in the outer layer (A) and have the function, in the invention, of stabilizing appearance, i.e. the mattness of the exterior layer after prolonged weathering. This incorporation of the additional particles is necessary, since otherwise the gloss of the film increases over the course of time (in application) (through UV-erosion of the outer layer), and this is undesirable for the application. Detailed information relating to the additional particles differing from the white pigments follows at a later stage below in the “Other particles” section.

In an advantageous embodiment moreover the base layer (B) comprises a UV stabilizer at a concentration of from 0.1 to 5.0% by weight, preferably from 0.2 to 4.5% by weight, and particularly preferably from 0.3 to 4.0% by weight (based on the total weight of the base layer (B)). Detailed information relating to the UV stabilizer follows at a later stage below in the “UV stabilizer” section.

The base layer (B) can likewise also comprise other stabilizers differing from UV stabilizers, examples being phosphorus compounds, such as phosphoric acid or phosphoric esters.

### Outer Layer (A)

The matt, white outer layer (A) applied by coextrusion to the base layer (B) is, like the base layer (B), comprised predominantly (i.e. to an extent of at least 50% by weight) of a thermoplastic polyester, preferably being comprised of at least 80% by weight thereof, particularly preferably at least 90% by weight thereof. The polyester involved is advantageously the same as also used for the base layer (B), optionally with the variation that, in order to make the film easier to produce, the polyester comprises from 4 to 30 mol %, preferably from 6 to 25 mol %, particularly preferably from 8 to 16 mol %, of units derived from isophthalic acid (IPA), where these molar percent data are based on the entirety (=100 mol %) of the dicarboxylic-acid-derived units of the polyester in said layer.

In a preferred embodiment of the invention, the polyester of the outer layer (A) is a copolyester comprised of terephthalic-acid-derived units and of isophthalic-acid-derived units, and of ethylene-glycol-derived units. The proportion of terephthalic-acid-derived units in said copolyester, based on the entirety (=100 mol %) of the dicarboxylic-acid-derived units of the polyester, is preferably from 70 to 96 mol %, and the corresponding proportion of isophthalic-acid-derived units is preferably from 30 to 4 mol %. Among these copolyesters, particular preference is given to those in which the proportion of terephthalic-acid-derived units is from 72 to 94 mol % and the corresponding proportion of isophthalic-acid-derived units is from 6 to 25 mol %. Very preferred copolyesters are those in which the proportion of terephthalic-acid-derived units is from 74 to 92 mol % and the corresponding proportion of isophthalic-acid-derived units is from 6 to 16 mol %.

As IPA content increases, the number of break-offs during film production falls markedly. However, on the other hand the UV resistance of the film falls measurably above 16 mol % of IPA-derived units, and above 30 mol % it becomes very poor. It is also surprising that the gloss of the surface of the outer layer (A) falls as IPA content increases, and therefore that use of isophthalic acid at the stated concentration for the outer layer (A) gives a film with particularly low gloss.

The polyesters for the outer layer (A) are also available commercially or can be produced by processes known to the person skilled in the art by copolymerizing the individual monomers or by way of masterbatches of various individual polymers in the form of a mixture or in the form of a blend.

In other respects, the information given above for the polymer structure of the base layer (B) is applicable.

The matt, white outer layer (A) comprises a white pigment at a concentration of from 2 to 15% by weight, preferably from 3 to 14% by weight, and particularly preferably from 4 to 13% by weight. The higher the proportion of white pigment in the outer layer (A), the higher the whiteness of the film, and the higher the UV resistance. However, if the concentration limits of the invention are exceeded the white pigment makes the film markedly more susceptible to problems during passage through machinery. Detailed information relating to the white pigment follows at a later stage below in the “White pigment” section.

The outer layer (A) moreover comprises particles at a concentration of from 1.0 to 7.0% by weight (based on the total weight of said layer), where these particles are particles differing from white pigments. The concentration of said other particles is preferably from 1.5 to 6.5% by weight and particularly preferably from 2.0 to 6.0% by weight. These particles provide the desired mattness for the application of the invention. If, in contrast, the outer layer (A) of the film comprises said other particles at a concentration of less than 1.0% by weight, the mattness is inadequate, and this means that the gloss is excessive (≧50 at 60°; in accordance with DIN 67 530). If, in contrast, the outer layer (A) of the film comprises the other particles at a concentration of more than 7.0% by weight, it then becomes more difficult to incorporate the particles homogeneously into the film, with resultant undesired inhomogeneity (caused by agglomerates) in the surface. Detailed information relating to the additional particles differing from the white pigments follows at a later stage below in the “Other particles” section.

In the invention, the outer layer (A) also comprises a UV stabilizer at a concentration of from 0.3 to 8.0% by weight, preferably from 0.5 to 3.0% by weight, and particularly preferably from 1.0 to 2.0% by weight. If less than 0.3% by weight is used, the film becomes brittle, and this is undesirable. If amounts above 8.0% by weight of a UV stabilizer are used, the low molecular weight of the UV stabilizer makes the intrinsic viscosity of the film too low, and this makes the film more susceptible to problems during passage through machinery. Detailed information relating to the UV stabilizer follows at a later stage below in the “UV stabilizer” section.

### White Pigment

In order to achieve the abovementioned properties, in particular the desired whiteness of the film, white pigments are incorporated into the base layer (B) and at least into one outer layer (A), but possibly also into any other layers that may be present. The statements below apply equally to all of the layers that use white pigments, but of course the types, properties, and concentrations of the white pigments in the relevant layers are identical or mutually independently different, within the limits stated below.

White pigments that may be used are by way of example titanium dioxide, barium sulfate, zinc sulfide, or zinc oxide. It is preferable to use TiO₂ as sole whitening pigment, since TiO₂ gives the desired whitening even when its concentration is lower (by a factor of about 2) than that of BaSO₄, ZnS, or ZnO, and it thus improves cost-effectiveness, and reduces the number of break-offs during production. The titanium dioxide can be either of the rutile type or else of the anatase type, or can be a mixture of rutile type and anatase type. It is preferable to use titanium dioxide of rutile type. When rutile TiO₂ is used, high whiteness is achieved even at relatively low concentration (in comparison with other white pigments). Addition of TiO₂ is particularly preferable when the TiO₂ has been coated/doped with inorganic material and optionally has also been coated with organic material. The preferred inorganic coatings or additives for the TiO₂ here are SiO₂, preferably Al₂O₃, and particularly preferably combinations of SiO₂ and Al₂O₃. The proportion of SiO₂ and Al₂O₃ is preferably >0.7% by weight (based on the TiO₂), particularly preferably >1.0% by weight, and very particularly preferably >1.5% by weight. However, a maximum of 10% by weight should not be exceeded. The inorganic coating components in the stated proportions by weight are particularly advantageous for the UV resistance of the films of the invention, since they reduce, or entirely suppress, the photosensitizing effect of the TiO₂, thus slowing the UV-aging of the film and providing UV-protection. On the one hand, the inorganic coating reduces the catalytically active TiO₂ surface area which can cause yellowing and embrittlement of the film, and on the other hand an organic coating has a favorable effect on the incorporation of the TiO₂ into the thermoplastic polyester (greater homogeneity of dispersion, no agglomerates/gels). Suitable types of TiO₂ are available commercially. Mention may be made of the following by way of example: R-105 and R104 from DuPont (USA) and RODI® from Sachtleben (Germany).

The white pigment can be added directly during the film-production process, for example to the extruder, but in a preferred embodiment of the invention it is added in the form of extrusion masterbatch to the polyester comprising no additives (“original polymer”, “clear polymer”). Typical concentration ranges for the white pigment (as defined above) in the extrusion masterbatch are from 20 to 70% by weight.

The d₅₀ grain size of the white pigment, in particular of the titanium dioxide, is advantageously from 0.05 to 0.5 μm, preferably from 0.15 to 0.35 μm.

The white pigments incorporated at the intended concentrations give the film a brilliant white appearance.

### Other Particles

In order to achieve the desired mattness, the white outer layer (A) also comprises, alongside the white pigment, particles differing from the white pigments. These additional particles are likewise present in the base layer (B). Surprisingly, here they provide retention of mattness over prolonged weathering times (weathering resistance of the film).

Particles which are typical, for promoting mattness of the film, and are therefore preferred, are inorganic and/or organic particles, for example calcium carbonate, silica (SiO₂), in particular amorphous silica, talc, magnesium carbonate, barium carbonate, calcium sulfate, lithium phosphate, calcium phosphate, magnesium phosphate, aluminum oxide, lithium fluoride, the calcium, barium, zinc, or manganese salts of the dicarboxylic acids used, kaolin, or crosslinked polymer particles, e.g. polystyrene particles or acrylate particles.

Alongside this, it is also possible to select mixtures of two or more different particles among these particles, or mixtures of particles with identical chemical composition but different particle size. The particles can be added at the respective advantageous concentrations, e.g. in the form of glycolic dispersion, to the polymers of the individual layers of the film, during the polycondensation process during the production of the polyesters, or by way of masterbatches during extrusion.

Preferred “other particles” are synthetic SiO₂ particles, in particular amorphous silica. These particles are incorporated very successfully into the polymer matrix. Examples of producers of particles of this type are Grace (US), Fuji (JP), Evonik (DE), or Ineos (GB).

It has proven particularly advantageous to use particles with a d₅₀ median particle diameter of from 2.0 to 10.0 μm, particularly preferably from 2.4 to 8.0 μm, and very particularly preferably from 2.6 to 7.0 μm. If particles with a diameter below 2.0 μm are used, the mattness of the film is inadequate and the gloss is therefore too high. Particles with a diameter greater than 10 μm generally cause filter problems.

### UV Stabilizer

A selection of suitable UV stabilizers is found in FR 2 812 299. Particular preference is given to UV stabilizers which act as UV absorbers, in particular those based on triazine, since these in particular exhibit high long-term stability (more than 10 years mostly being required in the construction sector). Particularly suitable materials here, alongside TINUVIN® 1577, are the triazine derivatives described as preferred in DE 10 2006 059 888 (A1).

The UV stabilizers not only reduce embrittlement (loss of mechanical properties) but also reduce or retard thickness erosion (=reduction of film layer thickness due to weathering).

### The Film

The desired whiteness (>75, preferably >80, particularly preferably >85) and the desired low transparency (<60%, preferably <50%, particularly preferably <40%) of the film are achieved mainly by virtue of the white pigment at the stated concentrations, in particular in the base layer.

If the concentration of the white pigment in the entire film and in particular in the base layer is below the values stated above, the whiteness is then below 75, and the film appears to the observer to be insufficiently white. Transparency is then also above 60%, and the film appears milky; the structure situated underneath the film can then be discerned. The transmission of light has a significant effect on the heat gain of a building. Films that transmit less light lead to less heat gain. In the construction industry it is then possible, by using films of this type that do not transmit light, to realize structures that are of interest for economic and environmental reasons. Particularly in southern regions, in hot areas in the vicinity of the equator, large amounts of energy are needed in particular in the summer months to operate air-conditioning systems. Reflective sheeting reduces heat transmission and thus reduces heat gain of buildings. It is thus possible to save considerable amounts of energy. The transparency of the films of the invention is therefore preferably below 60%, particularly preferably below 50%, and very particularly preferably below 40%.

In a preferred embodiment of the invention, in order to raise the whiteness further, optical brighteners can be added to the base layer and/or to the other layers of the film. An example of suitable optical brighteners is HOSTALUX® KS from Clariant or EASTOBRITE® OB-1 from Eastman.

As mentioned above, the high whiteness of the invention and the low transparency of the film are achieved when the amounts of white pigment used in base and outer layer are those of the invention. These limits have general validity. It has moreover been found that the total amount of white pigment in the film can be varied as a function of total film thickness, while respecting the individual limits for the individual layers. In a preferred embodiment, the total amount of white pigment (in % by wt., based on the composition of the entire film) in the film, as a function of total film thickness, complies with the following formula:

Total amount of white pigment [% by wt.]=a·x²−b·x+c

where
x is the total thickness of the film in μm,
a is from 0.001 to 0.002 [% by wt.·μm⁻²], preferably from 0.0013 to 0.0017 [% by wt.·μm⁻²], particularly preferably from 0.0014 to 0.0016 [% by wt.·μm⁻²],
b is from 0.25 to 0.37 [% by wt.·μm⁻¹], preferably from 0.27 to 0.35 [% by wt.·μm⁻¹], particularly preferably from 0.30 to 0.32 [% by wt.·μm⁻¹], and
c is from 15 to 22 [% by wt.], preferably from 17 to 21 [% by wt.], particularly preferably from 18 to 20 [% by wt.].

Compliance is necessary here—as stated above—with the quantitative upper and lower limits for the white pigment per layer. A total amount of white pigment within the limits set via the formula guarantees the whiteness of the invention and the low transparency in the invention at varying film thicknesses.

The thickness erosion (=film thickness reduction due to weathering effects) of the film of the invention after 5000 h of weathering is less than 5 μm of thickness loss, preferably less than 2.5 μm of thickness loss, and particularly preferably less than 1.5 μm of thickness loss. This reduction of thickness loss over the course of time in comparison with films of the prior art makes the film resistant to increasing gloss over the course of time.

The film of the invention comprises at least the base layer (B) and the outer layer (A). A preferred form of the film is comprised of three layers: the base layer (B) and outer layers (A) and (C) applied to the two sides of said base layer (B), where the outer layers (A) and (C) can be identical or different. The structure of the outer layer (A) has already been described in detail. The outer layer (C) preferably comprises the polyesters described for the base layer (B). In particular, the outer layer (C) preferably comprises the abovementioned “other particles”, in order to provide a further improvement in the processing performance of the film.

Between the base layer (B) and the outer layers (A) and optionally (C), there can optionally also be one or more intermediate layers. These can in turn be comprised of the polyesters described for the base layer (B). The intermediate layer can also comprise the usual white pigments described, the other particles described, and the additives described. The thickness of the intermediate layer is generally greater than 0.3 μm, and is preferably in the range from 0.5 to 15 μm, in particular in the range from 1.0 to 10 μm, particularly preferably in the range from 1.0 to 5 μm.

The respective thickness of the outer layers (A) and (C) is generally in the range from 2.0 to 15.0 μm, preferably in the range from 3.0 to 8.0 μm, and particularly preferably in the range from 3.5 to 5.0 μm, and the thickness of the matt outer layer (A) and of the outer layer (C) here can be identical or different.

The total thickness of the polyester film of the invention can vary within wide limits. It is generally in the range from 15 to 100 μm, in particular from 16 to 40 μm, preferably from 19 to 38 μm.

The proportion of the base layer (B), based on the total thickness of the film, is at least 50%, preferably at least 60%, and particularly preferably at least 70%.

As the thickness of the film decreases, it becomes more difficult to achieve adequate whiteness values, low transparencies, and low gloss values at economically acceptable levels of ease of production/ease of passage through machinery. Below a total film thickness of 15 μm, this becomes impossible to achieve. Furthermore, UV resistance falls as film thickness decreases.

As total thickness increases, weight per unit area increases. This reduces the possibility of cost-effective use; final manufactured products become too heavy, and the further use of these in the preferred construction applications is rendered difficult by the decrease in mechanical flexibility.

In summary, a particular feature of the film of the invention is weathering-resistant low gloss of the film surface (A), due to comparatively high UV resistance, and low transparency. It moreover exhibits good winding performance and good processing performance.

The film of the invention is suitable as external layer for various external structures in buildings. The sunlight is reflected, and the matt, white outer layer causes diffuse scattering of same. Interference with air traffic is avoided, and heat gain of buildings is reduced, with enormous resultant energy savings. An increase in the gloss of the matt external layer due to weathering is avoided by equipping the base layer not only with white pigments but also with matting particles.

The gloss of the film surface (A), measured at an angle of incidence of 60° is less than 50. In one preferred embodiment, the gloss of said side is less than 45, and in one particularly preferred embodiment it is less than 40. When the gloss of the film surface (A) is measured at an angle of incidence of 60° after a weathering test lasting 90 days it is still lower than 60, and in one preferred embodiment lower than 45, and in a particular embodiment lower than 40. The difference in the gloss prior to and after the weathering test lasting 90 days, measured at an angle of incidence of 60°, is at most 20 units, preferably at most 10 units, and particularly preferably at most 5 units.

The (Berger) whiteness of the film is greater than 75, preferably greater than 80, and particularly preferably greater than 85. The transparency of the film is <60%, preferably <50%, particularly preferably <40%.

### Functional Coating

At least one surface of the film of the invention can have been provided with a functional coating and/or treatment.

By way of example, the adhesion capability of the film surface can be improved by a corona or flame treatment, which usually follows the heat-setting (see below: Production process).

As an alternative, or in addition to the corona or flame treatment, the film can be provided, on one or both surfaces, with a known functional coating, where these provide properties such as antistatic properties, conductivity, improved adhesion properties, etc., to the film, where the thickness of the dry coating is from 5 to 2000 nm, in particular from 20 to 500 nm, and particularly preferably from 30 to 200 nm. The coating is preferably applied “in-line”, i.e. during the film-production process, advantageously by means of the “reverse gravure-roll coating” process or “Meyer rod” process. Examples of coatings which provide additional functionalities are acrylates as described in EP-A-0 144 948, or ethylene-vinyl alcohols, PVDC, or copolyesters as described by way of example in EP-A-0 144 878, U.S. Pat. No. 4,252,885 or EP-A-0 296 620. A more detailed description of the various layers, their composition, and processes for their application can be found in the documents mentioned, which are expressly incorporated here by way of reference.

### Production Process

The invention also provides a process for producing the polyester film of the invention by the coextrusion process known from the literature.

The procedure for said process is that the melts corresponding to the individual layers (A), (B), and optionally (C), (D), etc. of the film are coextruded through a flat-film die and are shaped to form a melt film, the resultant film is drawn off for solidification on one or more rolls, the film is then biaxially stretched (oriented), and optionally coated prior to or during a stretching process, and the biaxially stretched film is heat-set and optionally corona- or flame-treated on the surface layer intended for the treatment.

The biaxial stretching (orientation) process is generally carried out in sequence (sequentially), and preference is given here to the sequential biaxial stretching process in which stretching is first carried out longitudinally (in machine direction) and then transversely (perpendicularly to machine direction).

Firstly, as is usual in the coextrusion process, the polymer or the polymer mixtures for the individual layers is/are compressed and plastified in a respective extruder, and any additives provided can already be present here in the polymer or in the polymer mixture. It is preferable that said additives are added in the form of masterbatches to the starting polymer. The melts are then forced simultaneously through a flat-film die, and the extruded multilayer melt is drawn off on one or more take-off rolls, whereupon the melt cools and solidifies to give a prefilm. It is essential here to avoid temperatures above 307° C. for the die and for the melt, since otherwise there is a risk that gas evolution occurs from the UV stabilizer. It is preferable that the melt temperature is below 306° C. and ideally it is below 295° C.

The biaxial stretching process is generally carried out sequentially. Here, the prefilm is preferably first stretched longitudinally (i.e. in machine direction=MD) and then stretched transversely (i.e. perpendicularly to machine direction=TD). This leads to orientation of the polymer chains. The longitudinal stretching can be achieved with the aid of two rolls rotating at different speeds corresponding to the desired stretching ratio. The transverse stretching process generally utilizes an appropriate tenter frame, into which the film is clamped at both edges, then being drawn toward the two sides at elevated temperature.

The temperature at which the stretching process is carried out can vary relatively widely and depends on the properties desired for the film. The longitudinal stretching process is generally carried out at a temperature in the range from 80 to 130° C., and the transverse stretching process is generally carried out in the range from 80 to 150° C. The longitudinal stretching ratio is generally in the range from 2.5:1 to 5:1, preferably from 3:1 to 4.5:1. The transverse stretching ratio is generally in the range from 3.0:1 to 5.0:1, preferably from 3.5:1 to 4.5:1.

In the heat-setting that follows, the film is kept at a temperature of about 180 to 250° C. for a period of about 0.1 to 10 s. The film is then wound up conventionally.

A particular feature of the film of the invention is excellent optical properties, i.e. low gloss, high UV resistance, and low transparency, very good handling, and very good processing performance.

It has also been ensured that, during the production of the film, an amount in the range of about 20 to 60% by weight, based on the total weight of the film, of cut material, where this arises in relatively large amounts during the production of the film, can be returned to the extrusion process as regrind without any resultant significant adverse effects on the physical properties of the film, in particular its appearance.

The film accordingly has quite excellent suitability for use in various external structures of buildings, in particular for roof structures. The matt, white external layer causes diffuse reflection of incident sunlight. Heat gain is reduced in the building situated thereunder, and the diffuse reflection does not interfere with air traffic.

Table 1 below again collates the most important inventive and preferred film properties:

TABLE 1

| | | | | |
|---|---|---|---|---|
| | | Very | | |
| Preferred | Particularly | particularly | | Measurement |
| range | preferred | preferred | Unit | method |

Base layer B

| | | | | | |
|---|---|---|---|---|---|
| Concentration of whitening | 3-15 | 4-14 | 5-13 | % by wt. | |
| filler | | | | | |
| Filler concentration of | 1.0-7.0 | 1.5-6.5 | 2.0-6.0 | % by wt. | |
| additional particle | | | | | |
| d₅₀ particle diameter of | 2.0-10.0 | 2.4-8.0 | 2.6-7.0 | μm | As |
| other pigment system | | | | | described |
| UV stabilizer | 0.1-5.0 | 0.2-4.5 | 0.3-4.0 | % by wt. | |

Outer layer A (matt, white outer layer)

| | | | | | |
|---|---|---|---|---|---|
| Concentration of white | 2.0-15.0 | 3.0-14.0 | 4.0-13.0 | % by wt. | |
| pigment | | | | | |
| Filler concentration of | 1.0-7.0 | 1.5-6.5 | 2.0-6.0 | % by wt. | |
| additional particle | | | | | |
| UV stabilizer | 0.3-8.0 | 0.5-3.0 | 1.0-2.0 | % by wt. | |
| d₅₀ particle diameter of | 2.0-10.0 | 2.4-8.0 | 2.6-7.0 | μm | As |
| other pigment system | | | | | described |
| Thickness of outer layer A | 2.0-15.0 | 3.0-8.0 | 3.5-5.0 | μm | |

Film properties

| | | | | | |
|---|---|---|---|---|---|
| Thickness of film | 15-100 | 16-40 | 19-38 | μm | |
| Berger whiteness of film | >75 | >80 | >85 | | See |
| | | | | | description |
| Transparency of film | <60 | <50 | <40 | % | ASTM D1003-00 |
| Gloss of outer layer A at | <50 | <45 | <40 | | DIN 67530 |
| 60° prior to weathering | | | | | |
| test | | | | | |
| Coefficient of friction | <0.50 | <0.45 | <0.40 | | DIN 53375 |
| COF, side A with respect | | | | | |
| to side A | | | | | |
| Topography of side A | >100, <1500 | >150, <1250 | >200, <1000 | Elevations | As |
| | | | | per mm² > | described |
| | | | | 1.5 μm | |
| Average roughness Rₐ of | 100-1000 | 175-950 | 200-900 | nm | DIN 4768 |
| matt, white side A | | | | | |

The measurement methods used to characterize the raw materials and the films were as follows:

DIN=Deutsches Institut für Normung [German Institute for Standardization]

### ASTM=American Society for Testing and Materials

### Relative Viscosity (RV Value), Standard Viscosity (SV Value)

### Conversion of SV to RV

Standard viscosity SV is measured—by a method based on DIN 53726—by measuring the relative viscosity η_{rel.} of a 1% by weight solution of polymer in dichloroacetic acid (DCA) at 25° C. in an Ubbelohde viscometer. The dimensionless SV value is determined as follows from the relative viscosity η_{rel.}:

SV=(η_{rel.}−1)·1000

For this, the film or, respectively, polymer raw materials are dissolved in DCA, and the white pigments and particles are removed by centrifuging prior to measurement. The proportion of pigments is determined by ashing, and a correction is made for this by applying an appropriate increase in the weight of film used (in order to arrive at the abovementioned 1% by weight solution). The relationship is therefore:

Weight used=(Weight used as per specification)/((100−particle content in %)/100)

Intrinsic viscosity (IV) is calculated as follows from the standard viscosity:

IV=[η]−6.907*10⁻⁴ SV(DCA)+0.063096 [dl/g]

### Weathering (Based on DIN EN ISO 4892-3:2006):

Equipment: QUV/spray from Q-panel (UV fluorescence lamp)

Test cycle:
a. 4 h of UVA irradiation at 60° C. (black panel temperature)
b. 5 min of water spray during weathering
c. 4 h of condensation at 50° C.
d. Back to a

Irradiation intensity=0.89 W/m² at 340 nm (UV-A)

Prior to gloss measurement, the weathered film is cleaned using gentle pressure and rubbing with a moist paper tissue, to remove superficially adhering oligomer and other material.

### Gloss

Gloss is determined in accordance with DIN 67 530. Reflectance is measured, this being an optical value characteristic of a film surface. Using a method based on the standards ASTM D523-78 and ISO 2813, the angle of incidence is set at 60°. A beam of light hits the flat test surface (film) at the set angle of incidence and is reflected or scattered by the surface. A proportional electrical variable is displayed, representing light rays hitting the photoelectronic detector. The value measured is dimensionless, and must be stated with the angle of incidence.

### Whiteness

Whiteness is determined by the Berger method, generally by mutually superposing more than 20 layers of film. Whiteness is determined with the aid of an ELREPHO electrical reflectance photometer from Zeiss, Oberkochem (DE), standard illuminant C, 2° standard observer. Whiteness WG is determined as

WG=RY+3RZ−3RX

where RX, RY, and RZ are corresponding reflectance factors using an X, Y, or Z color-measurement filter. The white standard used comprises a barium sulfate pressing (DIN 5033, part 9). A detailed description is provided by way of example in Hansl Loos, Farbmessung [Color measurement], Verlag Beruf und Schule, Itzehoe (1989).
Measurement of d₅₀ Median Diameter (Median Particle Diameter)

d₅₀ median diameter is determined in a MASTERSIZER® from Malvern Instruments, GB, by means of laser scanning [an example of other measurement equipment being the HORIBA® LA 500 (Horiba Europe GmbH, DE) or HELOS® (Sympathec, DE), which use the same principle of measurement]. For this, the specimens are placed in a cell with water, and this is then inserted into the measurement equipment. A laser is used to scan the dispersion, and particle size distribution is determined from the signal via comparison with a calibration curve. The d₅₀ median value (=a measure of the average) characterizes the particle size distribution. The measurement procedure is automatic and also includes the mathematical determination of the d₅₀ value. The d₅₀ value is defined here as being determined from the (relative) cumulative particle size distribution curve: the intersection of the 50% ordinate value with the cumulative curve provides the desired d₅₀ value (also termed median) on the abscissa axis.

### Transparency

Transparency is measured in accordance with ASTM D1003-00 by HAZE-GARD PLUS® equipment from Byk-Gardner, USA.

Contact Angle with Water

The polarity of the surface is determined by measuring the angle of contact with distilled water. The measurement is made at 23° C. and 50% relative humidity. A metering syringe is used to apply a droplet of width 1-2 mm of distilled water to the film surface. Since the measurement is time-dependent because of heat introduced by the illumination system (vaporization), charging, or droplet-spreading, the needle remains in the droplet so that during the measurement the droplet is carefully enlarged and then the contact angle is read immediately through a goniometer eyepiece (measurement of advancing angle). The average is calculated from five measurements.

Examples are used below for further explanation of the invention.

### Inventive Example 1

The raw materials for the base layer (B) were dried and fed to the extruder for the base layer (B). Similarly, the raw materials for the outer layer (A) were dried and fed to the extruder for the outer layer (A).

A white two-layer film with AB structure and with total thickness 36 μm was then produced by coextrusion followed by stepwise longitudinal and transverse orientation. The thickness of the outer layer (A) was 5 μm.

Base layer (B):

| | |
|---|---|
| 63% by weight | of polyethylene terephthalate with SV |
| | value 800 |
| 12% by weight | of masterbatch from Sukano |
| | (Schindellegi, CH) with 50% by weight |
| | of R104 rutile titanium dioxide from |
| | DuPont (median particle diameter of |
| | titanium dioxide about 0.3 μm) and 50% |
| | by weight of polyethylene terephthalate |
| | with SV value 800 |
| 20% by weight | of masterbatch from Advansa, Turkey, |
| | with 1.5% by weight of SYLOBLOC ® 44H |
| | (SiO₂, d₅₀ = 2.5 μm) from Grace, |
| | Germany, and 98.5% by weight of |
| | polyethylene terephthalate with SV |
| | value 800 |
| 5% by weight | of masterbatch from Sukano |
| | (Schindellegi, CH) with 20% by weight |
| | of TINUVIN ® 1577 UV stabilizer from |
| | BASF, Switzerland, SV value 750, and |
| | 80% by weight of polyethylene |
| | terephthalate with SV value 800 |

Outer layer (A) is a mixture of:

| | |
|---|---|
| 14% by weight | of masterbatch from Sukano |
| | (Schindellegi, CH) with 50% by weight |
| | of rutile titanium dioxide (d₅₀ about |
| | 0.3 μm) and 50% by weight of |
| | polyethylene terephthalate with SV |
| | value 800 |
| 56% by weight | of copolyester with SV value 800, |
| | comprised of 95% by weight of |
| | copolyester of 78 mol % of terephthalic |
| | acid, 22 mol % of isophthalic acid, and |
| | 100 mol % of ethylene glycol, and 5.0% |
| | by weight of SiO₂ particles (SILYSIA ® |
| | 430 from Fuji, JP) with d₅₀ value |
| | 3.4 μm |
| 20% by weight | of copolyester with SV value 800, |
| | comprised of 95% by weight of |
| | copolyester of 99 mol % of terephthalic |
| | acid, 1 mol % of isophthalic acid, and |
| | 100 mol % of ethylene glycol, and 5% by |
| | weight of SiO₂ particles (SILYSIA ® 430 |
| | from Fuji, JP) with d₅₀ value 3.4 μm |
| 10% by weight | of masterbatch from Sukano |
| | (Schindellegi, CH) with SV value 750 |
| | with 80% by weight of polyethylene |
| | terephthalate with SV value 800 and |
| | 20% by weight of TINUVIN ® 1577 UV |
| | stabilizer from BASF, Switzerland |

The production conditions in the individual steps of the process were:

| Extrusion | Temperatures | Layer A: | 280° | C. |
|---|---|---|---|---|
| | | Layer B: | 280° | C. |
| | | Layer C: | 280° | C. |
| | Take-off | | 20° | C. |
| | roll temperature | | | |
| Longitudinal | Temperature (initial | | 70-120° | C. |
| stretching | T to final T) | | | |
| | Longitudinal | | 3.2 | |
| | stretching ratio | | | |
| Transverse | Temperature (initial | | 80-135° | C. |
| stretching | T to final T) | | | |
| | Transverse | | 3.8 | |
| | stretching ratio | | | |
| Setting | Temperature | | 230° | C. |
| | Duration | | 3 | s |

The film obtained had high UV resistance, high mattness, with very good winding performance, very good winding quality, and very good processing performance.

### Inventive Example 2

The film was produced as in inventive example 1. A latex with 4.5% by weight solids content, comprised of a copolymer of
60% by weight of methyl methacrylate,
35% by weight of ethyl acrylate, and
5% by weight of N-methylolacrylamide
   and of a surfactant, the remainder being water, was applied by the following process as adhesion-promoting coating to layer A of the polyester film:

The longitudinally stretched film was corona-treated (8 kW/m²) and then coated with the latex described above on the white, matt layer A by reverse gravure coating.

The biaxially stretched film was heat-set at 230° C. The dry weight of the coating was about 0.035 g/m², with a coating thickness (after drying) of about 40 nm.

The contact angle of the A layer surface with water was 67.5°. The reprographic adhesion of the film was tested and found to be good.

### Comparative Example 1

Example 1 was reproduced from EP-A-1 900 515. Gloss, measured at an angle of incidence of 60°, rose from 26 to 61 after the weathering test. The film therefore failed to comply with the criteria for application externally on buildings.

### Comparative Example 2

Example 1b was reproduced from EP-A-1 900 515 A1. Gloss, measured at an angle of incidence of 60°, rose from 27 to 56 after the weathering test. The film therefore failed to comply with the criteria for application externally on buildings.

Table 2 collates the results of the inventive examples/comparative examples.

TABLE 2

| | | | Gloss (60°), | | Coefficient | |
|---|---|---|---|---|---|---|
| | | | side A (=white, | Gloss (60°), | of friction | |
| | | | matt side) prior | side A (=white, | COF, side A | Contact |
| | Whiteness of | Transparency | to weathering | matt side) after | with respect | angle |
| | film | [%] | test | weathering test | to side A | [°] |
| Inventive example 1 | 92 | 30 | 10 | 11 | 0.34 | — |
| Inventive example 2 | 92 | 30 | 11 | 11 | 0.34 | 67.5 |
| Comparative example 1 | 93 | 30 | 26 | 61 | 0.32 | — |
| Comparative example 2 | 93 | 30 | 27 | 56 | 0.32 | 63.9 |

That which is claimed:

1. A white, biaxially oriented polyester film comprising at least one white, matt base layer (B) which comprises white pigment, and at least one white, matt outer layer (A) which comprises polyester and white pigment,
wherein the outer layer (A) and the base layer (B) comprise, alongside the white pigment, other particles which differ from the white pigment and which increase mattness, and which have a median particle diameter d₅₀ of from 2 to 10 μm, and which are present at a concentration of from 1.0 to 7.0% by weight (based on the composition of the respective layer) in each of the layers (A) and (B), where the particle diameter and the concentration in the two layers is identical or different;
the white pigment present in the outer layer (A) is present at a concentration of from 2.0 to 15.0% by weight;
and the outer layer (A) comprises a UV stabilizer at a concentration of from 0.3 to 8.0% by weight, based on the composition of the outer layer (A).

2. The white, biaxially oriented polyester film as claimed in claim 1, wherein one of the film surfaces has a functional coating or a functional treatment has been applied to said film surface.

3. The white, biaxially oriented polyester film as claimed in claim 1, wherein said film has three layers.

4. The white, biaxially oriented polyester film as claimed in claim 1, wherein the base layer (B) of the film has a polymer content of at least 80% by weight of thermoplastic polyester, where the percentage by weight is based on the polymer content of the layer, ignoring pigment content, particle content, or additive content.

5. The white, biaxially oriented polyester film as claimed in claim 4, wherein the thermoplastic polyester comprises at least 90 mol % of units derived from ethylene glycol and from terephthalic acid, or of units derived from ethylene glycol and from naphthalene-2,6-dicarboxylic acid, based on a molar basis of 100 mol % for the polyester.

6. The white, biaxially oriented polyester film as claimed in claim 5, wherein the thermoplastic polyester is polyethylene terephthalate homopolymer.

7. The white, biaxially oriented polyester film as claimed in claim 1, wherein the polyester of the outer layer (A) comprises from 4 to 30 mol % of units derived from isophthalic acid (IPA), where these molar percentage data are based on the entirety, =100 mol %, of dicarboxylic-acid-derived units of the polyester in said layer.

8. The white, biaxially oriented polyester film as claimed in claim 1, wherein the white pigment is titanium dioxide, barium sulfate, zinc sulfide, zinc oxide, or a mixture made of one or more of said white pigments.

9. The white, biaxially oriented polyester film as claimed in claim 8, wherein the titanium dioxide is rutile type that optionally has been coated with organic material.

10. The white, biaxially oriented polyester film as claimed in claim 9, wherein the titanium dioxide has been coated/doped with inorganic material.

11. The white, biaxially oriented polyester film as claimed in claim 1, wherein the total amount of white pigment in the polyester film is calculated from the formula:
Total amount of white pigment [% by wt.]=a·x²−b·x+c
where
x is the total thickness of the film in μm,
a is from 0.001 to 0.002, [% by wt.·μm⁻²],
b is from 0.25 to 0.37, [% by wt.·μm⁻¹], and
c is from 15 to 22, [% by wt].

12. The white, biaxially oriented polyester film as claimed in claim 1, wherein the particles that differ from the white pigments are selected from: calcium carbonate; silica; talc; magnesium carbonate; barium carbonate; calcium sulfate; lithium phosphate; calcium phosphate; magnesium phosphate; aluminum oxide; lithium fluoride; calcium, barium, zinc, or manganese salts of dicarboxylic acids; kaolin; crosslinked polymer particles, or mixtures thereof.

13. The white, biaxially oriented polyester film as claimed in claim 12, wherein the silica is amorphous silica and the crosslinked polymer particles are polystyrene particles or acrylate particles.

14. The white, biaxially oriented polyester film as claimed in claim 1, wherein the UV stabilizer is a triazine-based UV stabilizer.

15. The white, biaxially oriented polyester film as claimed in claim 1, wherein the whiteness is >75 and the transparency is <60%.

16. The white, biaxially oriented polyester film as claimed in claim 1, wherein the thickness erosion of the film after 5000 h of weathering is less than 5 μm of thickness loss.

17. A process for producing a polyester film as claimed in claim 1 comprising
coextruding the melts corresponding to the individual layers (A), (B), and optionally (C), (D), and (E) of the film through a flat-film die and shaping the coextruded melts to form a melt film,
drawing off the melt film for solidification on one or more rolls,
biaxially stretching the solidified film for orientation, and optionally coating said film prior to or during stretching,
heat setting the biaxially stretched film and optionally corona- or flame-treating a surface layer, and
winding the heat set and optionally surface treated film up.

18. Cladding for buildings or in structures of buildings comprising the polyester film as claimed in claim 1.

19. Cladding for buildings or in structures of buildings as claimed in claim 18, wherein said cladding is outdoor cladding.

20. Cladding for buildings or in structures of buildings as claimed in claim 18, wherein said structures are roof structures.
